(19) United States
(12) Patent Application Publication
(10) Pub. No.: US 2018/0052527 A1
(43) Pub. Date: Feb. 22, 2018

(54) AN INPUT DEVICE FOR THE DYNAMIC DISPLAY OF ICONS

(71) Applicant: Sonder Design Pty Ltd, Eveleigh (AU)

(72) Inventors: Francisco Serra-Martin, Eveleigh (AU); Felipe Serra-Martin, Eveleigh (AU)

(21) Appl. No.: 15/556,962

(22) PCT Filed: Mar. 9, 2016
(86) PCT No.: PCT/IB2016/051338

§ 371 Date: Sep. 8, 2017

(30) Foreign Application Priority Data
Mar. 9, 2015 (AU) 2015900829

(51) Int. Cl. G06F 3/023; G06F 3/02

(52) U.S. Cl. CPC G06F 3/0238; G06F 3/0219; G06F 3/0236

(57) ABSTRACT

A keyboard for dynamic display of key icons is described. The keyboard comprises an electronic display for displaying key icons. A controller operatively connected to the electronic display for controlling the display of the keyboard icons on the electronic display. Keyboard sub-assembly having a plurality of actuable keys disposed over the electronic display, wherein at least one of the keys is configured to facilitate viewing of the key icon therethrough, the keyboard sub-assembly also configured to facilitate transmission of a key actuation signal to the controller. The controller is configured to dynamically control key icon display mapping relative to one or more of the actuable keys on corresponding icon display zones of the electronic display.

### FIELD

The present application generally relates to input devices for computers, which include tablets, mice, joysticks, and other input controllers for computers. In particular, but not necessarily entirely, the present disclosure finds particularly effective application in keypads and keyboards.

### BACKGROUND

Input devices are many and varied, but they still have limitations. Keyboards, and keys generally, wherever they are found on input devices, generally consist of a fixed set of plastic keys having permanent markings on an upper surface of each one. Some markings, particularly on home keys, are tactile to as to increase productivity, and have raised markings on their surfaces. Other markings are painted characters and icons.

Keyboards are particularly limited because of the lack of a single lingue franca, spoken in every part of the world. Even if there were, to preserve a modicum of cultural identity, peoples of many nations prefer to maintain their own written language. A different keyboard must be obtained for each one, with different icons printed thereon, and a different number of keys.

Furthermore, there are many software tools, applications and games that, for more efficient operation, require their own separate keyboard, controller, iconography or arrangement of keys. To productively use these applications therefore requires additional investment, over and above the licence fees for the software itself.

The present invention seeks to ameliorate one or more of the abovementioned disadvantages or at least seeks to provide a new input controller to a computer.

### SUMMARY

In a broad aspect, the present technology provides an adaptive input device for a computer which adapts at least some of its input keys to individually display, or at least facilitate the viewing of, different icons in different circumstances.

In another broad aspect, the present technology provides a keyboard for the dynamic display of key icons, wherein different icons are viewable on or through at least some of the keys on the keyboard, depending on different contexts.

Broadly, the present technology provides a keyboard that is configured to display different key mappings in the same language, different language characters, or various other icons on or through the keys themselves or visible therethrough.

In accordance with one aspect of the present technology there is provided a keyboard for dynamic display of key icons, the keyboard comprising:

an electronic display for displaying key icons;

a controller operatively connected to the electronic display for controlling the display of the keyboard icons on the electronic display;

a keyboard sub-assembly having a plurality of actuable keys disposed over the electronic display, wherein at least one of the keys is configured to facilitate viewing of the key icon therethrough, the keyboard sub-assembly also configured to facilitate transmission of a key actuation signal to the controller;

wherein the controller is configured to dynamically control key icon display mapping relative to one or more of the actuable keys on corresponding icon display zones of the electronic display.

In accordance with another aspect of the present technology there is provided a method of dynamically displaying key icons on a keyboard, the method including the steps of:

displaying on a display panel, by an electronic display controller, a plurality of icons on an electronic display, each one of the plurality of icons being displayed on a selected icon zone of the electronic display corresponding to a plurality of key zones on a keypad overlay;

receiving a signal in the electronic display controller to update one or more selected icon zones on the electronic display with updated icons;

extracting the updated icons from a database and displaying the updated icon on the electronic display.

In accordance with yet another aspect of the present technology there is provided a keyboard for dynamic display of key icons comprising:

an electronic display;

a plurality of key mechanisms located adjacent the display;

a control processor operably coupled to the display to display dynamically configurable key icons for respective key mechanisms; and

a keypress detector adapted for detecting keypresses of the key mechanisms;

wherein the key mechanisms comprise a transparent portion adapted to allow visibility of respective key icons; and the keypress detector arranged not to obscure the transparent portion.

In accordance with still another aspect of the present invention there is provided a method of dynamically updating at least one of the icons displayed on an electronic display of a keyboard having a plurality of keys movable between a standby position and a depressed position, the method including the steps of:

receiving a notification of a change in state of a system to which the keyboard is connected;

updating the display of an icon display zone associated with one or more of the movable keys on an electronic display.

In an embodiment of the method, the change in state includes opening of an application on a computing device, connection to a computing device, switching on of the keyboard system, keypress on the keyboard.

The key mechanisms may comprise at least one scissor mechanism coupled to a key cap of the key mechanism, the scissor mechanism adapted to allow the vertical displacement of the key mechanism during a keypress.

The scissor mechanism may be located and orientated so as to not to obscure the transparent portion of the he key mechanism.

The key mechanisms may comprise oppositely located and vertically orientated scissor mechanisms.

The scissor mechanisms may comprise hingedly coupled scissor portions.

The scissor portion may be pivotably coupled at one end and slidably coupled at the other end.

The at least one scissor mechanism may be biased to bias the key cap upwards towards a non-depressed location.

The keypress detector may comprise a switch actuation tab fastened to the key cap and a complimentary switch wherein, in use, the switch actuation tab is adapted to actuate the switch when the key cap may be depressed.

The key mechanisms may comprise a hinge mechanism.

The hinge mechanism may be located at a lateral edge of the key cap so as to not obscure the transparent portion.

The keypress detector may be located opposite the hinge mechanism.

The keypress detector may comprise a switch actuation tab fastened to the key cap and a complimentary switch wherein, in use, the switch actuation tab may be adapted to actuate the switch when the key cap may be depressed.

The key mechanism may comprise at least one spring mechanism, the spring mechanism adapted to bias a key cap of the key mechanism upwards towards a non-depressed location.

The at least one spring mechanism may be located so as to not obscure the transparent portion.

The at least one spring mechanism may comprise oppositely located spring mechanisms.

The at least one spring mechanism may be a linear actuating spring mechanism.

The spring mechanism may comprise a coil spring.

The keypress detector may comprise a switch actuation tab fastened to the key cap and a complimentary switch wherein, in use, the switch actuation tab is adapted to actuate the switch when the key cap may be depressed.

The key mechanism may comprise a pneumatic key cap, the pneumatic key cap adapted to contact the keypress detector.

The keypress detector may be a touch sensitive overlay.

The pneumatic key cap may be air-filled.

The pneumatic key cap may be fluid-filled.

The electronic display may be front-lit.

The transparent portion may be adapted to act as a light waveguide.

The waveguide may have magnification properties.

The waveguide may have viewing angle altering properties.

The waveguide may have depth perception altering properties.

The depth perception altering properties are selected such that the displayed key icon appears to be displayed above the surface of the display device.

The viewing angle may be selected in accordance with an estimated position of the eyes of the user with respect to the keyboard when the keyboard is positioned for use.

The electronic display may be a monochrome display.

The electronic display may be a coloured display.

The electronic display may be bistable.

Electronic display may be an electrophoretic display.

The keypress detector may comprise a plurality of nets and a plurality of switch contact points operably coupled to the plurality of nets, wherein the plurality of nets are routed around areas corresponding to the locations of each transparent portion.

The keyboard may further comprise a peripheral display device.

The peripheral display device may be touch sensitive.

The keyboard may further comprise an I/O interface adapted for communicating with a computing device.

The I/O interface may be a wired I/O interface.

The wired I/O interface may be a USB interface.

The I/O interface may be a wireless I/O interface.

The wireless I/O interface may be a Bluetooth interface.

The control processor may be adapted to select the key icons for display in accordance with instructions received from the I/O interface.

The control processor may be adapted to receive key icon image data for display via the I/O interface.

The keyboard may further comprise a user interface.

The user interface may comprise a microphone.

The control processor may be adapted to select the key icons for display in accordance with voice commands received via the microphone.

The user interface may comprise a biometric reader.

The control processor may be adapted to select the key icons for display in accordance with a user identity identified by the biometric reader.

The control processor may be adapted to select the key icons for display in accordance with keypresses.

The control processor may comprise a memory device adapted for storing key icon image data.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a keyboard in accordance with embodiments of the present disclosure;

FIG. 2 shows various keyboard icons displayed by and viewable through or on the keys of the keyboard of FIG. 1 in accordance with an embodiment of the present disclosure;

FIG. 3 shows a schematic of a keyboard system in accordance with an embodiment of the present disclosure;

FIG. 4 shows the keypress detector of the keyboard system wherein the electrical nets of the keypress detector are routed to generally avoid any transparent portions of the keys;

FIG. 5 shows an embodiment of the key mechanism wherein the key mechanism comprises a scissor mechanism in accordance with embodiments of the present disclosure;

FIG. 6 shows an embodiment of the key mechanism wherein the key mechanism comprises a hinge mechanism in accordance with embodiments of the present disclosure;

FIG. 7 shows an embodiment of the key mechanism wherein the key mechanism comprises a spring mechanism in accordance with embodiments of the present disclosure;

FIG. 8 shows an embodiment where in the plurality of keys pneumatic in accordance with embodiments of the present disclosure;

FIG. 9 shows an embodiment wherein the plurality of keys are adapted for fastening to a computing device comprising a touch sensitive display device in accordance with embodiments of the present disclosure;

FIG. 10 shows an embodiment of the key mechanism wherein the key mechanism comprises a pivot mechanism in accordance with an embodiment of the present disclosure;

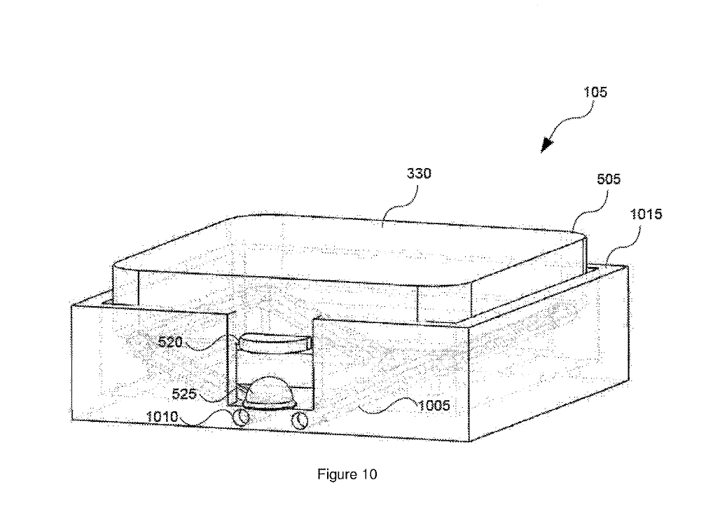

FIG. 11 shows an embodiment of the key mechanism wherein the key mechanism comprises a pivot mechanism in accordance with an embodiment of the present disclosure;

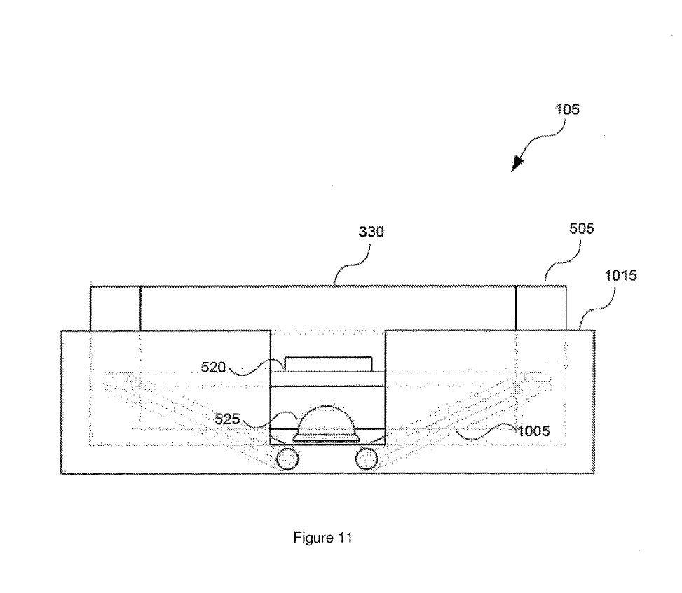

FIG. 12 shows an embodiment of the key mechanism wherein the key mechanism comprises a scissor structure;

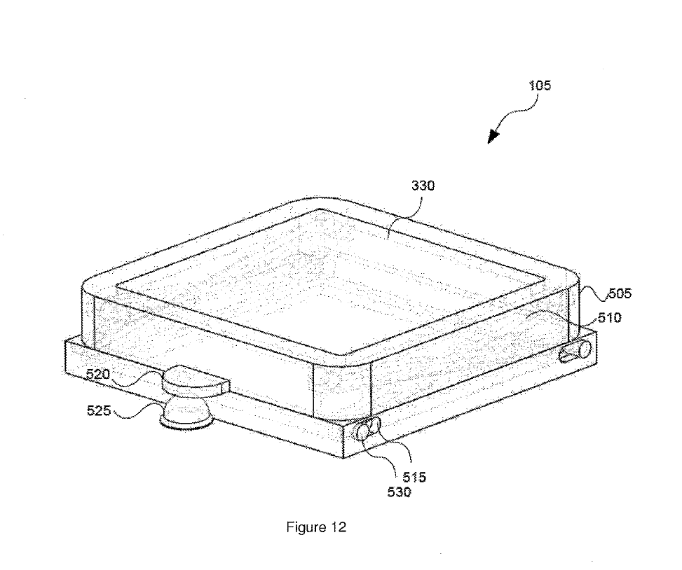

FIG. 13 shows an embodiment of the scissor structure as shown in FIG. 12;

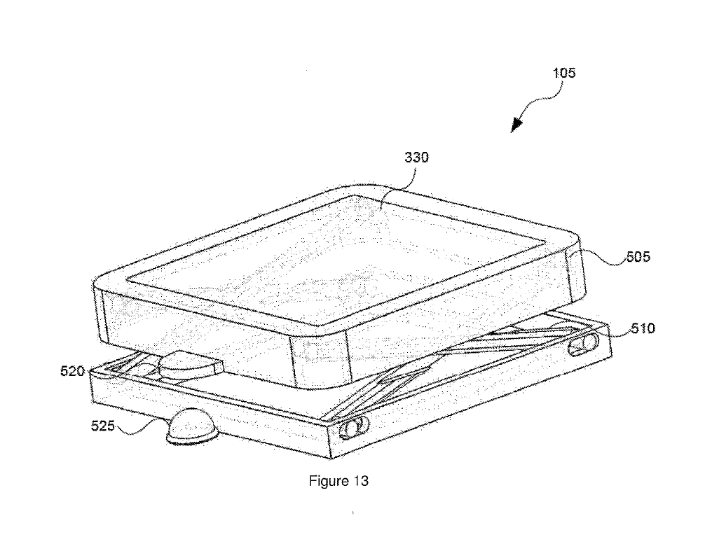

FIG. 14 shows a general arrangement drawing of a keyboard of an embodiment of the present technology, major elements shown exploded for clarity, showing in order from top to bottom:

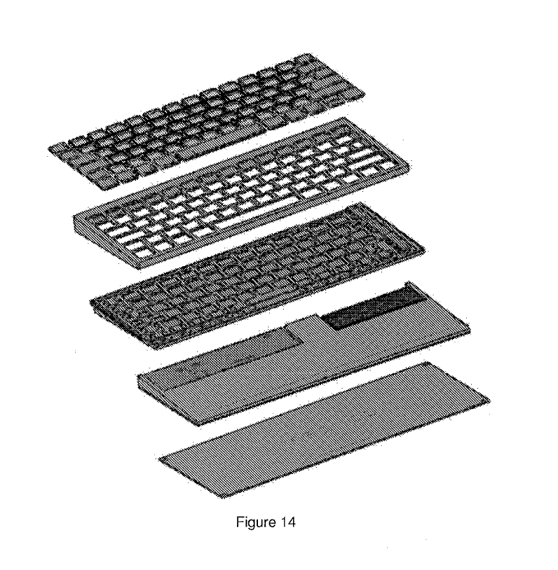

Dynamically adaptable and static keys;

Keyboard chassis;

Membrane and display module (including display and waveguide);

Backing structure (holding MCU and timing controller PCB in recess & battery); and

Back panel;

FIG. 15A is an isometric view of a key in accordance with a component of the present technology, and FIG. 15B is a plan view of same;

FIG. 16 is an isometric view of a key recess for receiving a key shown in FIG. 15A and FIG. 15B, and for guiding it as it moves between the standby and depressed positions;

FIG. 17 is an isometric view of a keyboard chassis element for supporting keys as shown in FIGS. 15 and 16;

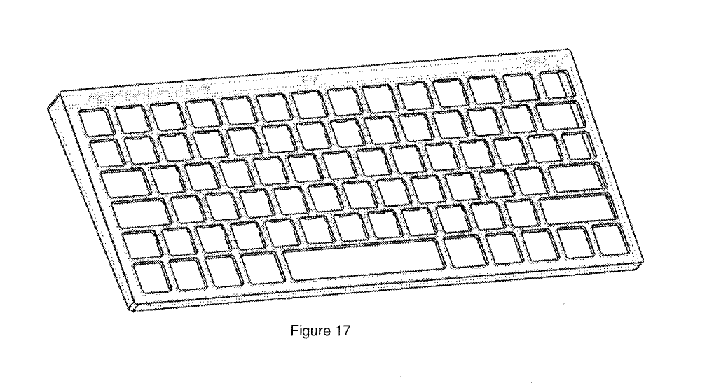

FIG. 18 is an isometric view of a display module with frontlighting waveguide illuminating the active area of the electronic display (EPD);

FIG. 19 is a side elevation view of a frontlighting waveguide illuminating the active area of the electronic display (EPD);

FIG. 20 is an exploded isometric view of a display module with waveguide, LED's and display along with display module chassis;

FIG. 21 is a similar schematic view of the software and hardware system as shown in FIG. 3 but with additional features and with interface with the computing device to which the keyboard is configured to be operatively connected;

FIG. 22 is a flow diagram showing steps instructed by the software of embodiments of the present technology;

FIG. 23 is a similar flow diagram showing steps instructed by the software of embodiments of the present technology.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

Before the structures, systems and associated methods relating to the keyboard are disclosed and described, it is to be understood that this disclosure is not limited to the particular configurations, process steps, and materials disclosed herein as such may vary somewhat. It is also to be understood that the terminology employed herein is used for the purpose of describing particular embodiments only and is not intended to be limiting since the scope of the disclosure will be limited only by the claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterised by,” and grammatical equivalents thereof are inclusive or open-ended terms that do not exclude additional, unrecited elements or method steps.

It should be noted in the following description that like or the same reference numerals in different embodiments denote the same or similar features.

Input and output defined:

The keyboard could provide displayable output and keyboard-type input functionality.

The term “input” will generally refer to the input signal that is provided by the keyboard upon activation of a key.

“Output” will generally refer to the display imagery produced by the E-ink display for a key to indicate its function, etc.

### Keyboard for the Dynamic Display of Key Icons

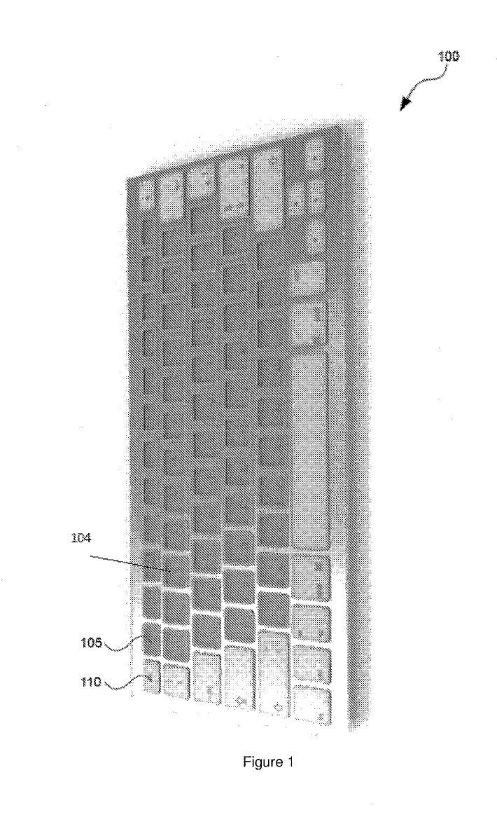

Turning now to FIG. 1, there is shown a keyboard 100 for the dynamic display of key icons.

The keyboard 100 comprises an electronic display adapted for displaying dynamic key icons depending on the desired application. As such, and as can be seen from FIG. 1, the keyboard 100 comprises a plurality of actuable key 104 in the form of key mechanisms 105 located adjacent the electronic display. Furthermore, and as will be described in further detail below, at least a portion of at least some of the key mechanisms 105 is substantially transparent so as to facilitate the viewing through the key of the adjacent dynamically displayed key icon by the display device.

As can be appreciated from the Figure, the keyboard 100, in embodiments, may comprise a mix of substantially transparent key mechanisms 105 and conventional nontransparent key mechanisms 110. However, in a preferred embodiment, all of the key mechanisms 100 are the substantially transparent key mechanisms 105 as primarily described herein.

In yet further embodiments, the keyboard 100 may comprise other electronic peripherals, either inbuilt or attachable, such as peripheral display devices and other user interface inputs and outputs.

The embodiments described herein will be used primarily for use for keyboard peripherals. However, it should be understood that the embodiments may be equally applicable to other computer peripherals requiring dynamic displays.

### Keyboard Architecture: Components Generally

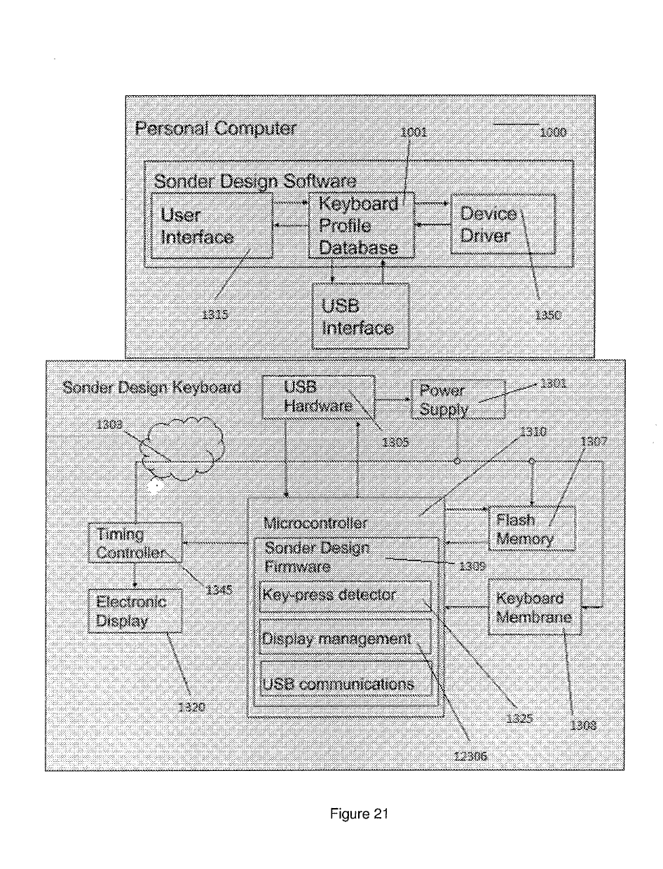

The keyboard 100 includes an I/O interface 305 system shown as a USB connecting system (1305 in FIG. 21) to facilitate the physical connection with and communication with the computer 1000. A power supply 1301 is provided to condition the voltage signal (5 volts) supplied by the USB to a selected tolerance level for the other components and distributes the power to those components. A flash memory 1307 is provided to store image data for keyboard profiles that can be displayed on the display 320 (EPD).

A timing controller 345, 1345 is connected to a microcontroller 1310, 310. The timing controller 1345 is configured to receive data from the microcontroller 1310 and generates appropriate electrical wave-forms that are sent to the electronic display (EPD) 1320 in order to display an image at a selected location (underneath a key). In use, display 1320 is updated by the timing controller 1345.

A keyboard membrane 1308 is provided, which is an array of momentary switches that generate an electrical signal when a switch is closed.

The microcontroller 1310 runs firmware 1309 that integrates all the signals it receives and sends during operation. It has the following parts:

A keypress detector 1325, which identifies when a key on the keyboard membrane 1308 has been pressed and generates and sends to the microprocessor a unique code corresponding to that particular pressed key associated with the displayed icon at that time;

Display management module 1306 updates the display 1320 to show appropriate information or keyboard profiles based on signals received from the computer 1000. It stores and retrieves image data in the flash memory 1307 and send it to the Timing Controller (TCON) 1345.

USB Communications module 1305 manages all information passing into or out of the device through the USB connection. It ensures that the display is up to date and that the keyboard is in the correct state to be compatible with the user's intentions.

### Dynamic Display of Key Icons

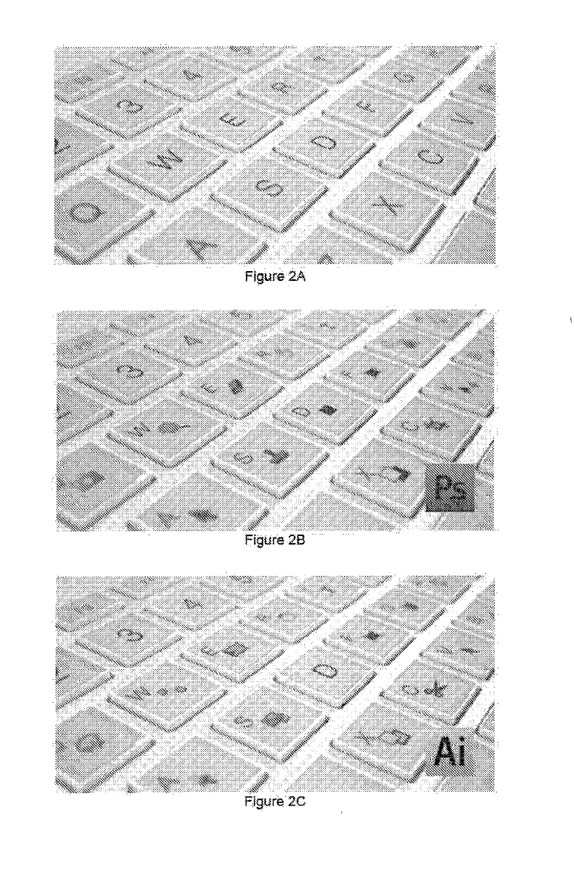

Turning now to FIG. 2, there is shown perspective views of the keyboard 100 wherein different keyboards are dynamically displayed.

Specifically, FIG. 2A shows the keyboard 100 displaying the conventional QWERTY key icons.

Now, FIG. 2B shows the keyboard 100 displaying a modified keyboard comprising key icon specifically for the Adobe Photoshop software application. As can be seen from this embodiment, the alphanumeric characters are displayed at the top left hand side of each key mechanism 105 and the Photoshop icon displayed in the middle of the key mechanism 105.

Yet further, and for further illustration purposes, FIG. 2C shows the keyboard 100 displaying a yet further modified keyboard comprising the keyboard configured specifically for the Adobe Illustrator software application.

As such, as can be appreciated, the keyboard 100 is adapted to display differing key icons for various applications such as for differing software applications, differing keyboard key mechanism layouts, differing regions, differing languages, user preferences, modify key instructions and the like.

### Keyboard System

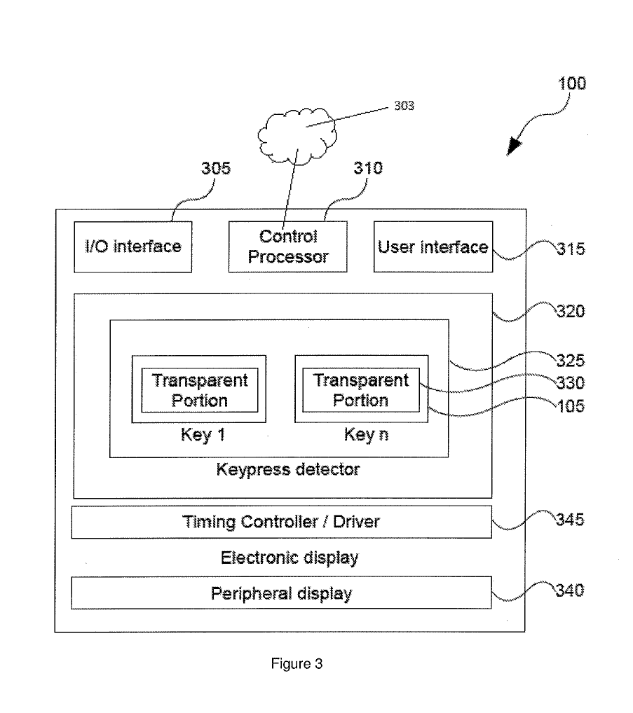

Turning now to FIG. 3 (very similar to FIG. 21 and hence may be discussed simultaneously), there is shown an exemplary functional schematic of the keyboard 100 system.

As can be seen, the keyboard 100 comprises an electronic display 320. As alluded to above, the electronic display 320 is adapted for displaying differing keyboards by displaying dynamic and individual key icons at locations corresponding to the location of each key mechanism 105.

In a preferred embodiment, the electronic display 320 is electrophoretic (E-ink) display, being preferably a bistable display advantageously not requiring continuous power for display purposes.

However, it should be noted that in embodiments, other electronic displays may be equally applicable, including LED, LCD display devices and the like.

In the embodiment shown, the keyboard 100 comprises a single display 320 rather than individual display devices for each individual key. In this manner, in use, the display 320 is controlled to display key icons at locations adjacent each key mechanism 105.

As such, adjacent the display device 320 are a plurality of key mechanisms 105. As alluded to above, each key mechanism 105 comprises a transparent portion 330 adapted to allow the visibility of the underlying key icon displayed by the display device 320. In certain embodiments as will be described in further detail below, the transparent portion 320 may comprise a waveguide to enhance the viewing of the key icon, such as by affecting the magnification, viewing angle and the like of the key icon.

The keyboard 100 further comprises a keypress detector 325 adapted to detect keypresses. Various types of keypress detectors 325 will be described in the embodiment that follow, including electrical contact and touch sensitive (such as capacitive) keypress detectors 325.

The keyboard 100 further comprises an I/O interface 305 for interfacing with a computing device. It should be noted that in embodiments 100, the keyboard 100 may be a standalone computer peripheral or inbuilt into a computing device, such as a laptop or the like.

As such, the I/O interface 305 may interface with the computing device in various ways. Where the keyboard 100 takes the form of a stand-alone computer peripheral, the I/O interface 305 may take the form of a wired interface, such as a USB interface. Alternatively, or additionally, the I/O interface 105 may offer wireless connectivity, such as by Bluetooth, for interfacing with the computer.

The keyboard 100 further comprises a control processor 310 for controlling the various functionality of the keyboard 100. The control processor 310 is operably connected to the display device 320 including for the purposes of displaying the key icons in the manner described herein.

In embodiments, the control processor 310 may comprise a memory device for storing the key icons, such as a way of image file such as bitmaps or like for selection for display. In alternative embodiments, the control processor 310 may interface with the computing device via the I/O interface 305 to retrieve the key icons for display.

Yet further, the control processor 310 is adapted to determine which key icons to display depending on the application. In embodiments, the control processor 310 may control the display of appropriate key icons in accordance with user interaction with the keyboard, such as the utilisation of modify keys, or other user interface input devices. In alternative embodiments, the control processor 310 may control the display of appropriate key icons in accordance with instructions from the attendant computing device, such as the above-mentioned differing key icons for differing software applications, locales and the like.

It is to be understood that certain components may be accessed by a network such as the memory storing key maps. A network module as shown at 1303 and 303 is connected to a remote server, to access the memory to obtain a key map, or icons, or other information or processing.

Yet further, the control processor 310 may be operably coupled to the keypress detector 320 for generating key mechanism codes corresponding to keypresses.

In embodiments, the computer 100 may comprise other user interfaces 315. For example, the keyboard 100 may comprise a microphone for various purposes including receiving voice activation instructions wherein, for example, the displayed key icons may be configured in accordance with user voice commands.

The user interface 315 may further be gesture receiving, such as by comprising a touch sensitive mouse trackpad or the like, microwave gesture detector, and the like.

In embodiments, the user interface 315 may comprise a finger print reader or other biometric data reader. In embodiments, the control processor 310 may be adapted to display keyboard icons in accordance with user preferences of the user identified via a finger print reader or other biometric data reader.

The user interface 315 may furthermore output information to the user, such as by way of audible or light output.

In embodiments, and as alluded to above, the keyboard 100 may comprise a peripheral display 340 for displaying peripheral information.

For example, in embodiments, the peripheral display 340 may be substantially elongate display located adjacent the function key mechanisms of the keyboard 100 so as to display various information appropriate to the function key mechanisms.

In other embodiments, the peripheral display 340 may display various keyboard modes of the keyboard 100 such as, and using the above example, whether the keyboard is displaying icons for Photoshop or Illustrator. In embodiments, the peripheral display 340 may be user configurable, such as by comprising a touch sensitive overlay or the like for allowing the user to interact with the peripheral display, such as, for example, by selecting appropriate key icon sets for display.

In embodiments, the peripheral display 340 may comprise an LED or LCD display.

In embodiments, as opposed to the peripheral display 340 being separate from the electronic display 320, the peripheral display in the electronic display 320 may be integral wherein a portion of the electronic display 320 is utilised for the purposes of displaying key icons whereas the remainder portion of the electronic display 325 extends beyond the key mechanisms 105 to display peripheral display information.

### Display

As alluded to above, in a preferred embodiment, the display 320 is in electrophoretic (E-ink) display. However, in other embodiments, differing display devices, such as LCD, LED display devices and the like may be equally applicable.

Furthermore, and are similarly alluded to above, the utilisation of a single display device 320 simplifies the construction of the keyboard 100 as opposed to having differing display devices for each key mechanism 105. In this manner, the durability and fault tolerance of the keyboard 100 is enhanced and furthermore, the display driver software is simplified.

In embodiments, the display 320 may be a monochrome display device. However, in other embodiments, the display 120 may be adapted to display colour also. In this regard, the display 320 may be a coloured E-ink display.

Although a electrophoretic (or E-ink) display 1320 will often be referred to in the examples discussed herein, this is non-limiting and it should be appreciated that the keyboard could use other display devices coupled to the base structure; e.g., a bistable display (a display which does not require power to drive the display), a LCD display, etc.

The E-ink display could be either a segmented or matrix E-ink display. Moreover, the E-ink display could be a monochrome or coloured E-ink display. The display imagery produced by the E-ink display could change, further increasing the functionality of the keyboard.

The keyboard 100 of preferred embodiments shown in the Figures facilitates viewing of the display imagery produced by the E-ink display “through” the keys.

A selected zone on the E-ink display 1320 is associated with a single key, and in some embodiments a zone can be associated with more than one key to provide the same function across multiple keys.

### User Interaction

As alluded to above, the keypress detector 325 is adapted to detect keypresses. The keypress detector 325 may take on differing arrangements for the purposes of detecting keypresses.

For example, in embodiments, the keypress detector 325 may detect keypresses through appropriate electro mechanical switch, or touch sensitive capacitive or resistive based detection technique.

As will be described in further detail below, the keypress detector 325 is configured to facilitate preservation of a view through the transparent portions 330 of the key mechanisms 105.

In a preferred embodiment, the keypress detector 325 is provided between the key mechanisms 105 and the electronic display 320. For example, in embodiments as will be described in further detail below, the keypress detector 325 comprises an XY matrix grid of electrical nets and appropriately located electro mechanical switches is adapted to detect the keypress of each key mechanism 105.

Alternatively, the keypress detector 325 may comprise a transparent touch sensitive overlay either standalone or inbuilt into the electronic display 320.

However, in other embodiments, the surface of each key mechanism 105 may be touch sensitive, such as wherein each key mechanism 105 is provided with an independent touch sensitive capacitance sensor or the like.

### Tactile Feedback

In the embodiment shown in the drawings, the key mechanisms 105 are adapted for physical displacement when pressed so as to provide conventional keyboard tactile feedback to the user.

The key mechanisms 105 may comprise rubberised footing or the like so as to not to damage the underlying display device 320.

Tactile structures provide the keyboard with a desirable feel, or action, in which a clicking or snapping occurs as keys are physically depressed to provide tactile user feedback. Selection of a tactile structure could be determined by the key's feel, the thickness of the keyboard, the performance of the E-ink display and like considerations.

A tactile structure, such as the tactile elastomeric dome(s) shown in the Figures at 1525, would elastically collapse by a tab or plunger portion of the key when the keycap is depressed from a rest position toward a fully depressed state, thereby providing tactile feedback to the user.

The tactile structure could include a spring or a tactile dome formed from metal, silicon, or other rubber-like dome structure.

Metal tactile dome could reduce the keyboard's thickness compared to other tactile structures.

Rubber-like tactile dome (or other tactile structures) could provide better tactile user feedback than a metal tactile dome, at the expense of increased keyboard thickness.

Whatever embodiment or material used, use of the tactile structure could provide tangible, haptic feedback which affirms that the user's physical movement (i.e., pressing of the key) has in fact sent the desired input.

For many of the plurality of keys, a tactile structure is provided on the chassis or the keyboard overlay to provide tactile user feedback when the key is depressed from a standby position toward (or relative) to the base structure.

Coincident with this tactile feedback, a switch is activated to produce the electronic input signal associated with the key's function.

The tactile structure is provided on the chassis or the keyboard overlay of the keyboard in a location that is centrally offset relative to the transparent central piece of the key so as to:

not to optically interfere with the through-key viewing of the E-ink display; and maximise the usable display area of the E-ink display

### Transparent Portion 330

Now, as alluded to above, in a preferred embodiment, each key mechanism 105 comprises a transparent portion 330. Preferably, the transparent portion 330 located at a substantially central portion of each key mechanism 105 so as to allow for the viewing of the appropriate key icon substantially within the centre of each key mechanism 105.

For example, each key mechanism 105 may be manufactured from transparent polycarbonate, acrylic or other transparent plastic to allow the transmission of the light from the display device 320 through the transparent portion 320.

As alluded to above, the mechanical arrangement of each key mechanism 330 and the keypress detector 325 may be adapted not to interfere with the visibility of the key icons through the transparent portion 330 of each key mechanism 105.

The key mechanisms 105 may comprise a matte or other finish depending on the desired application especially for reducing reflection and/or distortion of the key icons displayed by the display device 325.

### Gesture-Based Interactivity (Both Hardware and Software)

In some embodiments, dynamic keys are provided with touch or gesture-based interactivity and/or an interactive, touchscreen E-ink display through capacitance-based technology or resistive based method and like technology.

It is contemplated that display functionality is provided in other areas of the keyboard, such as a secondary display situated above the function keys or remotely connected to the keyboard which could also be provided with touch or gesture-based interactivity and/or an interactive touchscreen E-ink display through capacitance-based technology or resistive based methods and like technology.

It is contemplated that touch input(s) would facilitate user interaction with the keys to conduct context based gestures to perform assigned functions on the user's keyboard or computer.

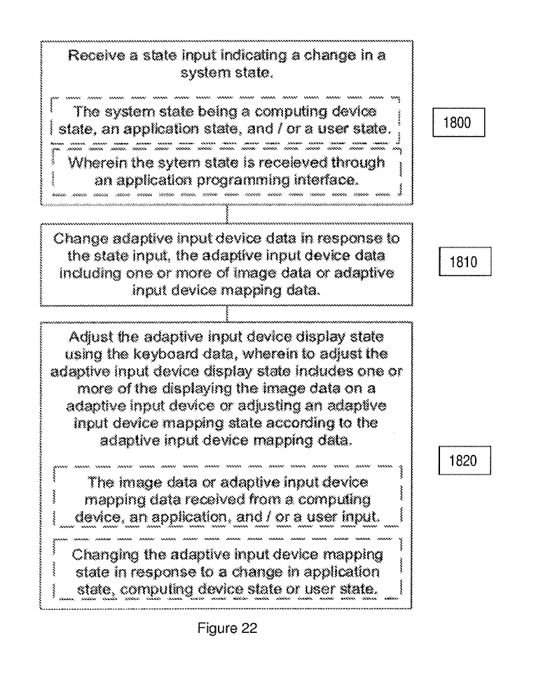

Touch input(s) would be detected by the keyboard's software through the touchscreen functionality of a E-ink display, the pressure-sensitive touch or motion sensor(s), or a webcam on the user's computer as shown in FIG. 22.

Based on touch or motion input(s), the keyboard's software could detect a gesture to perform an assigned function on the user's keyboard or computer, e.g., the keyboard's software could detect an assigned gesture(s) of the user and activate a program on the user's computer, dynamically change the keyboard's mapping and like functions.

### Physically Depressible Keys

Although the term “keys” will be used primarily, this term is non-limiting, and includes any structure or mechanism that could be moved by a user to provide input.

The keyboard includes a chassis structure and a plurality of keys where each of the plurality of keys is selectively physically depressible to a depressed position relative to the chassis to cause an input signal for controlling the user's keyboard or computer, after which the keys return to an elevated or standby position upon release.

### Optical Waveguides

In one embodiment, the transparent portion 330 comprise optical waveguides adapted to affect the depth, magnification, viewing angle and the like of the key icons displayed on the display 1320.

For example, the optical waveguide may be adapted to magnify the displayed key icon such that the display management device 325 may utilise smaller discrete display zones for the purposes of displaying each key icon, so as to advantageously save energy.

Furthermore, the optical waveguide may be adapted to modify the viewing angle such that the display icons are best viewable at an angle most appropriate to the usual location of the eyes of the user with respect to the keyboard 100 when the keyboard 100 is used on a flat surface, such as a desk.

In embodiments, the locations of the key icons may be offset in accordance with a user selection so as to interact appropriately with the waveguide. For example, the waveguide could comprise a non-linear viewing angle wherein the specific location of each icon alters the perceived viewing angle by the user.

In further embodiments, the optical waveguide may be adapted to alter the perceived depth of the displayed key icon such that, as opposed to the key icon appearing to be displayed at the level of the surface of the display device 320, the key icon would appear to be displayed towards the surface of the key mechanism 105.

In embodiments, the transparent portion 330 may be moulded so as to provide the optical waveguide capabilities. In alternative embodiments, a separate optical waveguide may be fastened to the key, such as by mechanically fastened, glued or the like to the transparent portion 330.

The optical waveguide may comprise convex, concave or other surface profile for the purposes of providing the desired way of guiding functionality.

It should be noted that the optical waveguide may be fastened to the key mechanism 105 so as to move with the key, or alternatively be static, such as by being fastened to the surface of the display device 320 so as to remain static despite the key mechanism be impressed.

### Other Embodiments of Waveguide

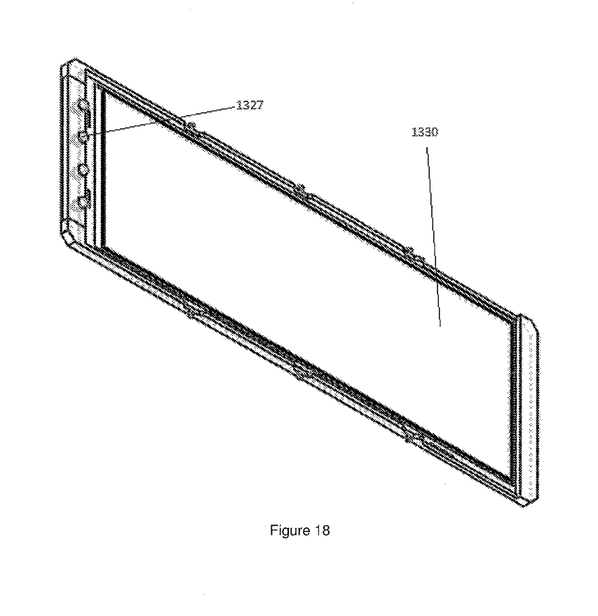

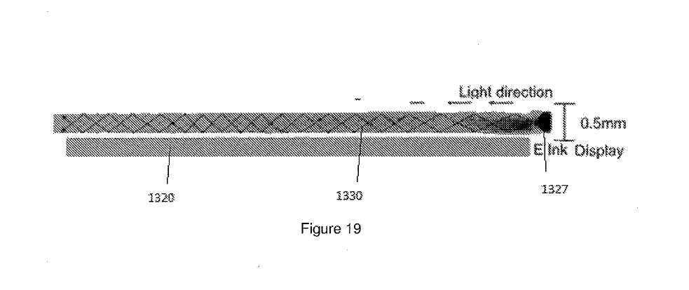

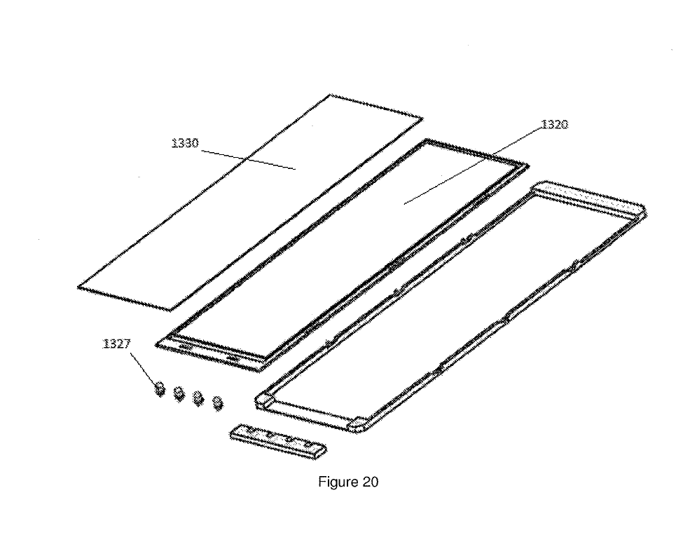

Shown in FIGS. 18, 19 and 20 there is shown a plurality of light emitting devices, in this embodiment being Gallium nitride-based light-emitting diodes arranged at the edge of a diffuser, which itself is in the form of an optical waveguide 1330.

The optical waveguide 1330 is shown as a separate element transposed above the electronic display 1320. It is contemplated that it could be integrated with the display by co-molding to or laminating to the display 1320, or it could be joined to the electronic display through an adhesive, snap-fitting, ultrasonic-welding or any other suitable joining method.

The waveguide acts to redirect the light from the light source, for example light emitting diodes to the active area of the display. The light diffuser's purpose is to distribute light evenly on the electronic display which is done by having tiny holes in the layer. Closest to the LED 1327 source the holes are less densely spaced, while further away from the light source the tiny holes are more concentrated in area. It is contemplated that the waveguide includes one or more convex, concave or undulating surfaces.

With the arrangement as shown in the FIGS. 18 to 20 and using parts of the embodiment described, only four LED's 1327 are required to achieve sufficient lighting across the keys and onto the electronic display. Advantageously, this reduces power and financial costs due to efficient use of light emission compared to traditional back lighting solutions which use 70+LED's.

### Keypress Detector

As alluded to above, in a preferred embodiment, the keypress detector 325 is adapted to not interfere with the visibility of the displayed key icon by the display device 320.

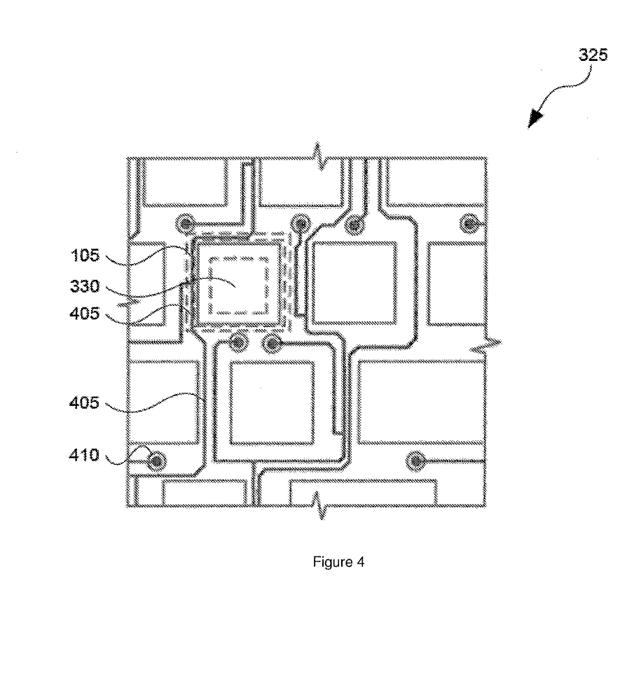

As such, referring to FIG. 4, there is shown an embodiment of the keypress detector 325 comprising an electrical network wherein the electrical network is arranged so as to not interfere with the display of the displayed key icons by the display device 320.

Specifically, as can be seen, the electrical network is arranged so as to avoid the central transparent portions 330 of each key mechanism 105 location.

As can be seen, the electrical network comprises a plurality of nets 405 and a plurality of electro mechanical switch contact points 410. As can be seen, the nets 405 and electro mechanical switch contact points 410 are arranged so as to not coincide with the central transparent portion 330 of each key mechanism 105 location.

In a preferred embodiment, an integral structure comprising a plurality of key mechanisms 105 and the inbuilt keypress detector 325 may be provided. In this manner, the integral structure may be overlaid on the display device 320.

### Direct Switch Keyboard

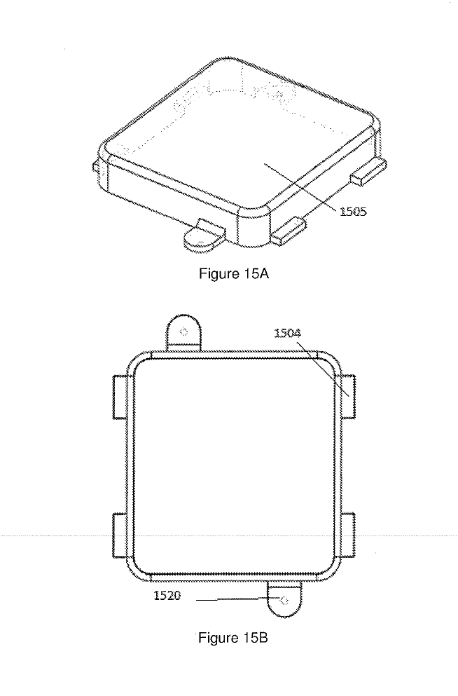

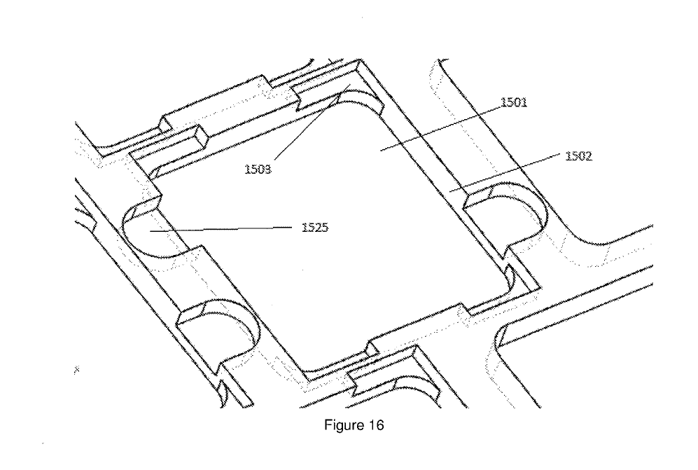

The keyboard assembly 100 in preferred embodiments and shown (at least in relation to the keys) in FIGS. 15 and 16 includes a direct switch keyboard. The keyboard 100 thus includes a chassis, a plurality of keys 1505, each one disposed within a recess 1501 having opposed walls 1502 and guides 1503 adapted to constrain the keys to a generally perpendicular linear movement between a standby position and a depressed or actuated position.

The recess 1501 seeks to maintain the key 1505 in linear alignment during movement and ensures that the movement is substantially constrained to perpendicular reciprocating linear movement between the standby position in which the key is biased away from the base structure and the depressed or actuated position proximal the base structure, without twisting or tilting.

Followers 1504 are provided, in some embodiments in the form of tabs on each key which extend from the edges thereof, so as to engage with the guides 1503. The followers 1504 are provided toward a periphery of its associated key so as to facilitate the transmission of as much light as possible from the E-ink display 1320, thereby ensuring that substantially all the transparent portions of the key (usually the finger plate) is unobstructed and available for visibility of the icon on the E-ink display 1320.

In some embodiments some or all of a portion of the perimeter of the key 1505 is contemplated to be opaque to substantially obscure or conceal any mechanism adjacent the key perimeter so that it does not interfere with the viewing of the E-ink display through the key.

The tactile structures and switches are provided at the periphery of the keys so as to minimise or eliminate any interference with the through-key viewing of the E-ink display 1320 while maximising the usable display area of the E-ink display 1320.

The tactile structure in embodiments shown in FIGS. 15 and 16 is provided directly by contact between actuating arms and the dome switch structure/s.

The dome switch structure (not shown but disposed at 1525) is elastomeric and biases the key towards the standby position.

Followers 1504 in the embodiments shown have a focus nipple to concentrate force directly on the dome switch upon actuation during a key press.

### Scissor Mechanical Embodiment

There will now be described various useful mechanical embodiments of the key mechanisms 105.

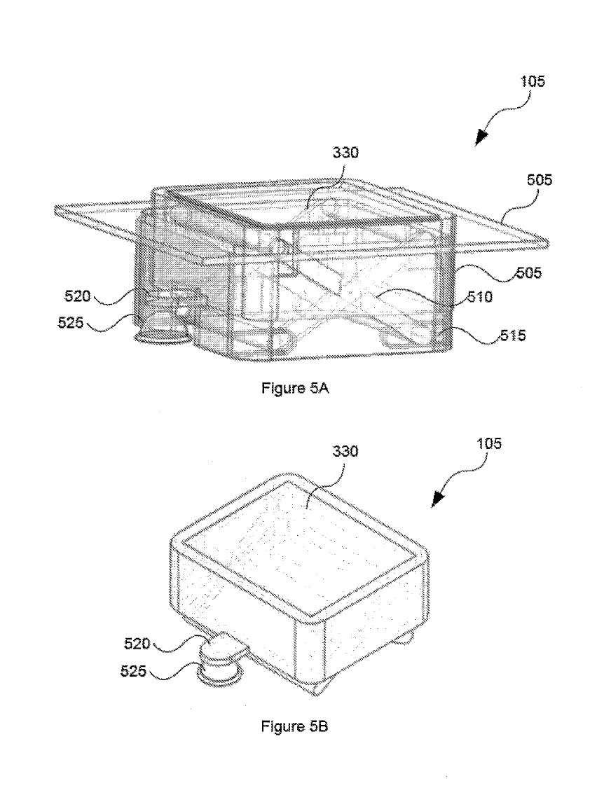

Specifically, referring to FIG. 5, there is shown a key mechanism embodiment referred to herein as the scissor embodiment.

As can be seen, the key mechanism 105 comprises a scissor arrangement 510 adapted to allow the key mechanism 505 to travel vertically with respect to the keyboard surface 505. This arrangement 510 furthermore maintains the upper surface of the key mechanism 105 parallel with respect to the keyboard surface 505.

As can be seen, the scissor arrangement 510 is located towards the edges of the key mechanism 505, such that the transparent portion 330 is not obscured.

As can be seen, the scissor arrangement 510 is pivotably coupled to the key cap 505 at the upper portions of the scissor arrangement 510. The lower portions of the scissor arrangement 510 is similarly pivotably yet also slidably coupled to the key mechanism 105 to accommodate the lateral movement of the lower pivot points during a keypress.

The key mechanism 105 is biased upwards so as to resume a non-pressed configuration. In this manner, the scissor arrangement 510 may be biased towards a non-pressed configuration, such as by comprising appropriately located spring, biasing flange or the like.

In embodiments, the periphery of the key cap 505 may be translucent or nontransparent so as to substantially obscure the inner mechanical arrangements, while yet substantially maintaining the substantially transparent central portion 330.

As also be seen, in this embodiment, the key mechanism 105 comprises a switch actuation tab 520 adapted to bear downwardly upon an electrical switch 525 to detect a keypress.

### Hinge Mechanism Embodiment

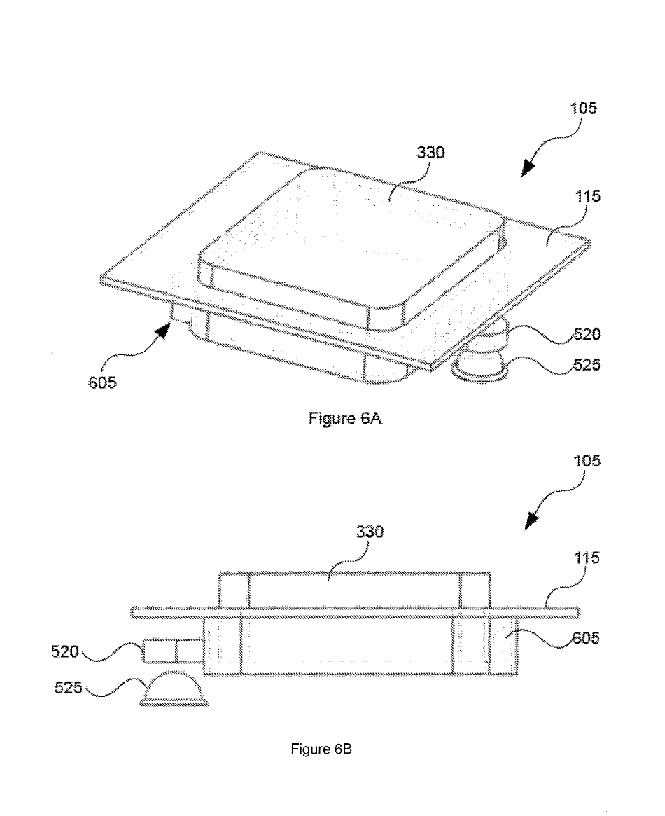

Turning now to FIG. 6, there is shown in alternative embodiment of the key mechanism 105 wherein the key mechanism utilises a hinge mechanism.

In this embodiment, the key mechanism 105 comprises a hinge 605. When the upper surface of the key mechanism 105 is depressed, the key mechanism 105 pivots about the pivot point 605 such that the switch actuation tab 520 depresses the electrical switch 525.

In this embodiment, the switch actuation tab 520 and the switch 520 may be arranged, including by being located proximately such that a keypress does not result in a discernible change in the angle of the upper surface of the key mechanism 105.

Again, it should be noted that also in this embodiment, the substantially centrally located transparent portion 330 is not obscured by the hinge arrangement such that the key icon displayed by the electronic display 320 remains visible to the user.

### Spring Structure Embodiment

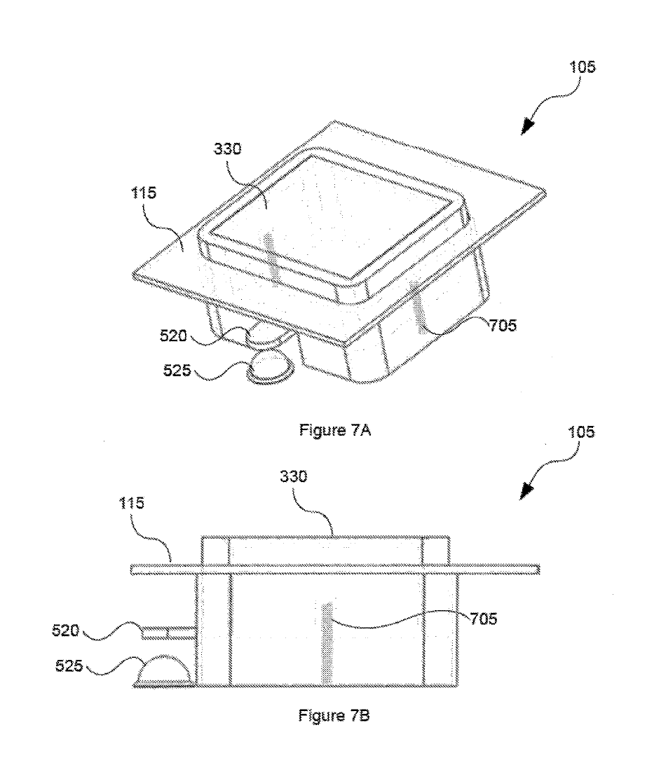

Turning now to FIG. 7, there is shown a yet further embodiment of the key mechanism 105 wherein, as can be seen, the key mechanism 105 comprises a spring mechanism 705 to bias the key mechanism cap 505 upwards.

Specifically, as can be seen, the key mechanism 105 comprises oppositely located springs 705 which bias the key mechanism upwards. Similarly, the depressing of the key mechanism causes the key mechanism actuation tab 320 to contact the electrical switch 525.

The lateral and opposite location of the spring structures 705 again do not obscure the transparent portion 330 of the key mechanism 105.

It should be noted that in other embodiments, other spring structures 705 may be employed, including spring structures not necessarily be vertically orientated or linear actuating as is shown substantially on the image.

Furthermore, in the embodiment shown, the spring structure 705 is shown as a conventional coiled wire spring but in other embodiments, the spring structure 705 may take on different configurations, such as a plastic deflectors and the like.

### Pneumatic Keyboard Embodiment

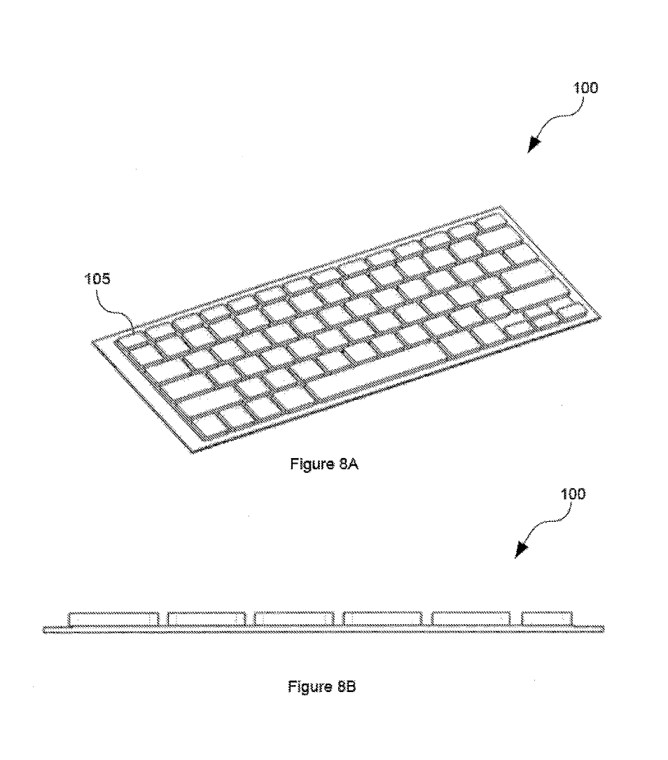

Turning now to FIG. 8, there is shown a further embodiment wherein the keyboard 100 takes the form of a pneumatic keyboard.

In this embodiment, each key mechanism 105 may be manufactured from transparent resilient and elastic plastic, rubber or the like. Furthermore, each key mechanism 105 may be fluid filled, such as with a liquid such as water, oil or the like or air filled.

In this manner, when depressing key mechanism 105, the upper inner surface of the key mechanism 105 will contact a surface beneath the key mechanism which may be detected by the keypress detector 325.

As alluded to above, the keypress detector 325 may be a separate layer located between the key mechanisms 105 and the electronic display 320. In other embodiments, the keypress detector 320 may be implemented by a touch sensitive electronic display 325.

### Touch Sensitive Display Device Keyboard Overlay Embodiment

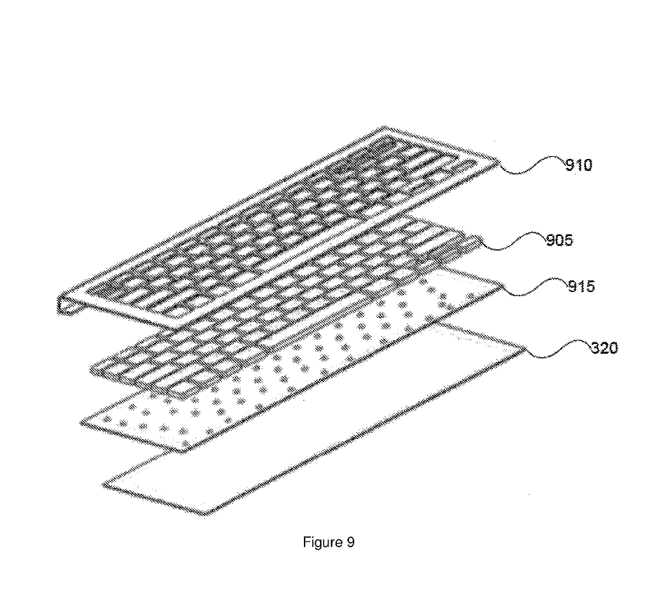

Turning now to FIG. 9, there is shown a touch sensitive display device keyboard overly embodiment.

In this embodiment, the electronic display 320 is touch sensitive. Indeed, many tablet computing devices existing today have touch sensitive display devices. As such, in this embodiment, the keyboard 100 may take the form of a selectively attachable keyboard comprising the plurality of key mechanisms 905 and a key mechanism frame 910 adapted to locate and secure the plurality of key mechanisms 905 to the electronic display 320.

In embodiments, the keyboard 100 may comprise a key mechanism underlay 915 such as a rubberised mat or the like comprise rubberised dimples, for example a dome switch adapted to make contact with the electronic display 320 at predetermined locations.

In this manner, the computing device comprising the electronic display 320 may be programmed to recognise keypresses at the predetermined locations corresponding to each key mechanism 105 of the plurality of key mechanisms 905.

In embodiments, the keyboard 100 may be easily removable so as to utilise the computing device electronic display 320 and the normal manner.

Again, it should be noted that in this embodiment, the key mechanisms 105 and the mat underlay 915 are transparent so as to allow the viewing of the displayed key icons.

### Software

### Bitmap Mappings

Software is provide and stored on the controller processing system 1310. The adaptive keyboard software's driver 1350 is configured to store in memory a library of bitmap mappings to form the display imagery produced by the E-ink display.

The user can engage and disengage (i.e., turn on or off) the adaptive keyboard software (e.g., the user can disengage the keyboard adaptive software and program the keyboard to map QWERTY, etc).

### Device Management Module

The adaptive keyboard software of the present embodiment includes a device management module 1350 to detect a keyboard 1000 in communication with the user's computer.

### Profile Management Module

The keyboard 100 software includes a profile management module 1001 which detects auser's keyboard profile upon them signing in with their Password and/or fingerprint ID; the user's profile defining their data (e.g., mapping, language, macros, etc).

The profile management module is configured to retrieve the user's profile from a server stored locally or remotely via a network (e.g., the internet/the cloud).

The profile management module is made available via an API to be engaged by a third party application, which configures the third party application to detect and adapt to the data contained in the user's third party application profile (e.g., where the user's keyboard is mapped in Mandarin, an application like Facebook or Twitter is instructed to adapt by displaying in Mandarin).

Where the keyboard is one of a plurality of adaptive devices in communication with the user's computer, the profile management module is configured to detect the other profile(s) for the other adaptive devices via the API.

### Transport Protocols

The keyboard's driver 1350 provides support for various transport protocols, such as Universal Serial Bus (USB), Transport Control Protocol over Internet Protocol (TCP/IP), Bluetooth, etc.

### Application Adaptive Example

The keyboard software is configured through its I/O port shown in FIGS. 3 and 21 (USB hardware) to connect to the computing device and the driver 1350 detects and adapts intuitively to an active application on a user's computer by changing the keyboard mapping to adapt to the operational context of that application.

The keyboard will adapt to application specific events by mapping display imagery (e.g., in interactive media like video games, certain images or keys may animate to reflect or alert the user to engage with certain key(s)).

A change in application state could be detected by the adaptive keyboard software if the application is an active, whether the application is operating in the computing background, whether there are different states within the application while the application is active, etc.

The adaptive keyboard software could change the keyboard mapping in response to the state input indicating a change in application state; computing device state; or user state.

### Change in Application State Example

If a user in a word processing application selects text, the change in application state could be detected by the adaptive keyboard software and have the auxiliary display provide formatting options (e.g., bold, italic, underline, text colour/highlight, etc).

The previous actions of the user could be ranked according to frequency, a recent change, etc regarding the change in the application state, and the keyboard display could adapt intuitively and display a list of options for the user to select.

Context based controls on an input device could increase productivity and enable the user to become advanced users more quickly and eliminate the need to navigate complex second-tier UI, drop down menu's etc with their mouse.

### Computing Device State Example

Where there is a change in application state, such as a slideshow presentation application is opened, the software sets a state where the application queries the user if they are creating a new slideshow or if the user wants to open a recent slide show.

In the case that the user elects to open a recent slide show, the adaptive keyboard software could detect this change in application state via the I/O module 1305 and have the auxiliary display list the most recent slideshow presentations that have been opened in chronological order, etc.

Once a slide show is selected, the adaptive keyboard software could detect another state change and display on the auxiliary display options within the opened slideshow.

Advantageously, as the user navigates the opened slideshow, or as the user selects an animation to include in the slideshow, functionality associated with the navigation or the animation could be displayed to the user through the keyboard display(s) 1320, enabling the user to select the functionality through the keyboard without keystroke sequences that take the user into the menu options.

### User State Example

The change in system state to drive a keyboard mapping change is in one example, a change in the user's computer state in communication with the keyboard.

A change in the user's computer state includes a computer turning on, turning off, going to sleep, being placed in a standby state, turning on a screen saver, etc as non-limiting examples.

The keyboard is configured to detect the change in the user's computer state via the I/O device management module 1305, which then displays on the keyboard display(s) 1320 user options regarding the change in computer's state.

In that sense, a detectable change in the user's computer state is displayed to the user through keyboard display(s) 1320 using the adaptive keyboard software.

A change in the user state can be detected when the user touches the keyboard (detected via accelerometer not shown); when a keyboard is moved or picked up; when the user is approaching a keyboard; when the user presses one or more keys, or a key sequence; when the user interacts with an interactive display on the keyboard that is displaying one or more user options, etc.

In that sense, when a user state changes, the keyboard display(s) could change in response to the user state change.

### Location Adaptive Example

Where the keyboard is being used in a geographical location (e.g., China), the keyboard software detects this location via I/O 1305 and adapts intuitively by interrogating a lookup table of languages corresponding with the present location either:

prompting the user if they wish to have their keyboard mapping read in the local language or dialect of that location (e.g. Mandarin), or

adapting intuitively by changing the keyboard mapping to read the local language or dialect (e.g. Mandarin).

### OS Adaptive Example

The adaptive keyboard software could detect and adapt to the user's preferences and settings (e.g., mapping, language, macros, etc) set on their computer's operating system (Apple's Mac OS, Microsoft Windows, Linux etc), and changes the keyboard mapping accordingly.

### Modifier Keys Example

The keyboard provide conventional QWERTY alphanumeric input capability, in addition to other inputs.

Keys could provide functionality for various languages and alphabets, and/or to activate other input commands for controlling the user's computer.

The keyboard software could enable the user to create macros (i.e., keyboard shortcuts) with a ‘Macro key’ to assign keys particular functions to provide other inputs according to the user's preference.

Depressing and holding multiple keys simultaneously, or in sequence, could provide commands that control the operation of the user's keyboard or computer. For example, the “ALT GR” key could be assigned to enable the user to select different languages or keyboard mappings (i.e., from QWERTY to DVORAK mapping). Also, the “CTRL” key could be assigned to enable the user to observe the respective application specific shortcut assigned to the keys (e.g., when the CTRL is engaged, a print icon is mapped to the “P” key). The “COMMAND” or “WINDOWS” key could be assigned to enable the user to select their user-generated macros to perform simple repetitive tasks or application shortcuts. The “SHIFT” and “CAPS LOCK” key could be assigned to change the letters to the respective uppercase or lowercase letter or secondary function (e.g., Shift+1=!).

### Display Imagery

The keyboard could provide a wide variety of displayable output to enhance and otherwise augment the computing experience.

The keyboard could cause a display of viewable output on or near the individual keys to indicate the key's function.

For example, instead of keys with letters painted or printed onto the keycap surface, the E-ink display could display the letter “P”, etc and display the key's function (e.g., an icon of a printer).

This dynamic and programmable display capability could facilitate potential use of the keyboard in a variety of different ways so that each key could be easily changed to reflect the different key assignments.

The E-ink display capability could provide any type of viewable output to the user, and is not limited to alphabets, letters, numbers, symbols, etc.

The keys could be displayed in a manner that is not necessarily associated in a spatial sense with an individual key.

An image could be presented in a region of the keyboard that spans multiple keys and need not be associated with the input functionality of the keyboard.

Images could be provided for aesthetic purposes, to personalise the user experience, or to provide other types of output.

The present disclosure encompasses display output for any purpose.

### Online Library

The user could access a comprehensive online library of keyboard mappings created by Sonder Design Pty Ltd or by users who generate and upload their unique keyboard mapping to share online.

The online library could include user generated Macros with unique functions and iconography (e.g., a macro to open a new internet browser window with the respective browser icon assigned as the macro image, etc).

### Firmware

### Firmware's Functionality

In an Electrophoretic Display (EPD), charged microcapsules (each filled with electrophoretic fluid) are suspended in a solvent (dielectric fluid) between two conductors (one of the which is transparent).

The charged pigment particles of white color are charged with positive charges, and the charged pigment particles of black color are charged with negative charges.

When a voltage difference is imposed between the two electrodes, the pigment particles migrate to one side or the other, according to the polarity of the voltage difference—as a result, an image is formed.

The driving methods for this change in polarity is long given the viscosity of dielectric solvent which limit the moving speed of the charged pigment particles.

To reduce the driving time, the system uses a display driver 1350 and timing control unit 1345 to apply driving voltages only to the updated areas, and apply no driving voltages to the non-updated areas—causing a partial update.

This embodiment saves a lot of power during operation of the keyboard.

### Driver

The driver could drive each pixel with the voltages corresponding to the control signals which form the display imagery.

A driver could mitigate the reduction of the display imagery produced by the E-ink display caused from switching voltage polarity rapidly, in addition to mitigating excessive power consumption and eliminating possible signal interference.

### Timing Controller

A timing controller 1345 generates a control signal according to an externally applied signal via 1305 (I/O).

The timing controller 1345 could provide sequentially output control signals which correspond to a positive high voltage, a negative high voltage and a ground voltage respectively to the source driver.

### Configuration Interface

The database contains all the information such as keybindings and image to key mappings for a given keyboard profile and stores all user profiles. This database exists locally on the user's computer but may be uploaded to, downloaded from or modified via the Sonder cloud service shown at 303, 1303.

### Database

The configuration interface allows the user to create new, or modify existing keyboard profiles and manage the database.

### Device Driver Functional Interrelationships

The device driver 1350 manages communication with the Sonder keyboard and sends key press events to the operating system. It works with the display management to identify which zone and therefore icon was selected, and passes that signal to computer 1000.

Keyboard Mapping on Display Area with Cartesian Coordinates

The Keyboard configuration software is itself configured to display on a computer device display screen, a user interface configuration panel with clickable areas, over the image of a Sonder Keyboard—with clickable areas corresponding to a button on a physical Sander keyboard.
The act of clicking on a key in this overlay allows the user to select and subsequently configure options for the physical Keyboard key—such as the image that will be displayed in the keys area, automatic device actions as a consequence of the user hitting the key, and possibly other features.
Internally, the clickable area of the interface is divided up into a grid. A table of key positions and dimensions is maintained by the software, and Mouse Clicks are directly mapped to Keys by means of Cartesian coordinate geometry.
The mapping of mouse clicks to specific keys is calculated using the following algorithm:
A mouse click gives: (mouse click x,mouse click y) coordinates
For each Key in the Table:
Check if (mouse click x, mouse click y) is within the area defined by Key Position x, Key Position y) and (Key Position x+Key width, Key Position y+Key height), if so return this Key
   Where Key Position x and Key Position y define the top right hand corner of a button

### Software Flow

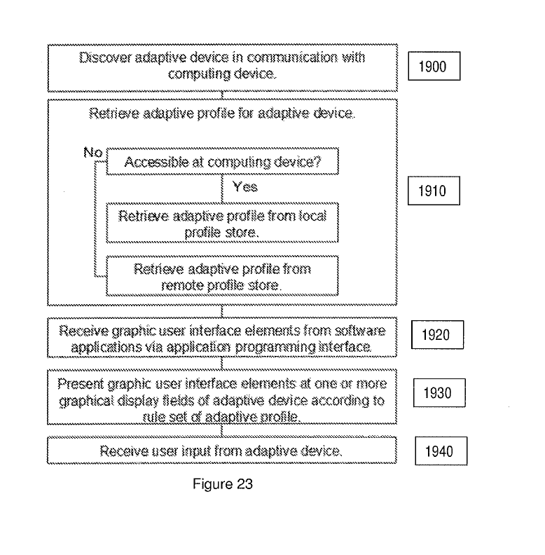

FIGS. 22 and 23 show flow diagrams for software decisions for the keyboard 1000. The flow diagrams show that the system is instructed to leave the display as it is and wait to receive a state input indicating a change in state (step 1800). Once, say, an application state change is received through the API (device driver 1350) then the system is instructed to change the display (step 1810). Then, the microprocessor 1310 adjusts the state of a portion of the display via the Timing Controller (TCON 345).

FIG. 23 steps through the steps of adjusting state of a dynamically adjustable keyboard 100 when the keyboard 100 is first connected and turned on.

### Advantages of Embodiments of the Technology

Keyboard with a Single E-Ink Display:

### Advantage:

This embodiment would reduce power consumption as it would require only a single driver, TCON module and electronics board.

The simplicity of the mechanical architecture would:

significantly reduce the engineering and hardware costs incurred with design and manufacturing;

make it easier for software engineers to program because there is only a single E-ink display to program; and

increase mass production capability and low cost desired in a highly competitive marketplace.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms

1. A keyboard for dynamic display of key icons, the keyboard comprising:
a bistable display for displaying a plurality of key icons across a plurality of key icon display zones;
a controller operatively connected to the electronic display for controlling the display of the key icons on the bistable display;
a keyboard sub-assembly having a plurality of actuable keys disposed over the bistable display, wherein at least one of the actuable keys is configured to facilitate viewing of the key icon therethrough, the keyboard sub-assembly also configured to facilitate transmission of a key actuation signal to the controller;
wherein the controller is a timing controller configured to dynamically control key icon display mapping relative to one or more of the actuable keys on corresponding key icon display zones of the bistable display.

2. The keyboard in accordance with claim 1 wherein the keyboard overlay includes a frontlit display element provide greater visibility to the bistable display, the display element including a light source and a diffuser to light the bistable display.

3. The keyboard in accordance with claim 1 or 2 further comprising an I/O interface adapted for communicating with a computing device.

4. The keyboard in accordance with any one of claim 1 to 3 wherein the timing controller includes a computing processor which is configured to select the key icons for dynamic display mapping in accordance with instructions received from applications running on a computing device and sent via an I/O interface.

5. The keyboard in accordance with any one of claims 1 to 4 wherein the controller includes a control processor configured to receive key icon image data for display from a computing device and sent via the I/O interface.

6. The keyboard in accordance with any one of claims 1 to 5 further comprising a configuration interface.

7. The keyboard in accordance with claim 6 wherein the configuration interface includes a microphone for receiving configuration instructions.

8. The keyboard in accordance with claim 6 or 7 wherein the configuration interface includes a biometric reader.

9. The keyboard in accordance with any one of claims 1 to 8 wherein the control processor is configured to select the key icons for display in accordance with a user identified by the biometric reader.

10. The keyboard in accordance with any one of claims 1 to 9 wherein the control processor is configured to display the key icons in accordance with keypresses.

11. The keyboard in accordance with any one of claims 1 to 10 further including a memory device configured for storing key icon image data.

12. The keyboard in accordance with any one of claims 1 to 11 wherein the keyboard includes a keypress detector which includes a plurality of nets and a plurality of switch contact points operably coupled to the plurality of nets, the arrangement being such that the plurality of nets are disposed on areas proximal an edge of a key to the locations of each transparent portion.

13. The keyboard in accordance with any one of claims 1 to 12 wherein the keys include finger panels which are substantially transparent.

14. The keyboard in accordance with any one of claims 1 to 13 wherein the plurality of keys are movable from a standby position to an actuating position.

15. The keyboard in accordance with any one of claims 1 to 14 wherein each one of the plurality of keys includes a biasing element to bias each key to the standby position.

16. The keyboard in accordance with any one of claims 1 to 15 wherein at least some of the plurality of keys includes a key element disposed in a key guide to facilitate movement between the standby position and the actuating position.

17. The keyboard in accordance with any one of claims 1 to 16 wherein at least some of the plurality of key elements include followers to facilitate movement in respective ones of the key guides.

18. A method of dynamically updating at least one of the icons displayed on an electronic display of a keyboard having a plurality of keys movable between a standby position and a depressed position, the method including the steps of:
receiving a notification of a change in state of a system to which the keyboard is connected;
updating the display of an icon display zone associated with one or more of the movable keys on an electronic display.

19. The method of claim 20 wherein the change in state includes opening of an application on a computing device, connection to a computing device, switching on of the keyboard system, keypress on the keyboard.
